(19) United States
(12) Patent Application Publication
(10) Pub. No.: US 2007/0147798 A1
(43) Pub. Date: Jun. 28, 2007

(54) DVD player with function of displaying variable sentences simultaneously and method for producing subtitles thereof

(75) Inventor: Jen-Chi Chang, Taipei County (TW)

Correspondence Address: BACON & THOMAS, PLLC, 625 SLATERS LANE, FOURTH FLOOR, ALEXANDRIA, VA, 22314, US

(73) Assignee: Nuvofilms. Com, Inc, New Castle County, DE (US)

(21) Appl. No.: 11/645,060

(22) Filed: Dec. 26, 2006

(30) Foreign Application Priority Data
Dec. 23, 2005 (TW) 094146080

(51) Int. Cl. H04N 5/00

(52) U.S. Cl. 386/125

(57) ABSTRACT

The present invention is to provide a DVD player with function of displaying variable types of sentences simultaneously and a method for producing subtitles thereof. The system includes system resolution apparatus, a subtitle generation unit, a video decoding unit, a video subtitle composing unit, video outputting apparatus and a subtitle producing unit. The method of producing subtitles in the subtitle producing unit includes intercepting subtitles, compiling subtitle graphic files, transforming subtitle graphic files and storing them into subtitle displaying table. Through a video subtitle composing unit, the video and the subtitle displaying table composed of variable sentences in different language are linked and then transmitted to video output apparatus. Thus, the subtitle containing more than one languages in the DVD video are displayed with variable sentences simultaneously. The displayed sentences are marked with corresponding displaying time to benefit a user in browsing both the displayed and the un-displayed sentences so as to achieve objects both of video watching and language learning.

### BACKGROUND OF THE INVENTION

1. Field of the Invention

The present invention relates in general to a DVD player with function of displaying variable sentences simultaneously and a method for producing subtitles thereof, and especially to a DVD player of displaying variable subtitles with more than one types of sentences in the DVD video simultaneously to benefit the users in browsing and learning the sentences back and forth.

2. Description of the Related Art

A prior art DVD player was disclosed in the U.S. Pat. No. 5,907,658. In the disclosed DVD player, the digital data, after being read from a DVD disc into a buffer memory area, was separated into video stream, audio stream and subpicture stream by the de-muxer unit 2. Each stream, then, was transmitted to the MPEG video decoding unit 3, the audio decoding unit 4 and the subpicture decoding unit 5, respectively. The results were transmitted to the audio output apparatus 6 by the audio decoding unit 4 to output digital audio signals. Hereinafter, the results were transmitted to the video/subpicture composing unit 7 by the video decoding unit 3. The subpicture decoding unit 5 only decoded the subpicture data in the pre-determined language and then transmitted the results to the video/subpicture composing unit 7. Through mixing by the video/subpicture composing unit 7, the video were transmitted to the video output apparatus 8. However, such a DVD player allows the user to choose only one subtitle from the multiple subtitles to display. Further, during displaying, the subtitle can only show with a single sentence.

Languages-comparison function is lacked in such a DVD system so that the users can not learn a foreign language by comparing different languages therefrom. Therefore, a bilingual-style learning environment can not be created by such a DVD system to the users.

Referring to FIG. 2, another prior art DVD reproduction system was described in the Taiwanese Patent No. 522,379. In this system, a new route was so established that a loader can accept a second type of control signal (that is, subpicture control signal) from the user interface, and two kinds of subtitles can be displayed on the screen at the same time through a new data decoding procedure. The executed result from such a system is shown in FIG. 2. By the DVD double subtitle displaying system 9, a single sentence such as “I Love You, Son” which was the only one type of subtitle in an original DVD display screen 91 was changed into a subtitle with two types of sentences such as “I Love You, Son.

[symbol]

However, the so-described multi-media DVD display system only allows one or two types of subtitles to display at the same time and only one sentence is allowed to display each time. Sentences with a quantity more than two are not allowed to display simultaneously. Moreover, neither the displayed sentences nor the un-displayed sentences are allowed to browse by the users. If a system intends to allow more than two types of sentences to display simultaneously, an additional subtitle database has to be established in a DVD disc. However, to establish an additional subtitle database in a DVD disc is not so frequently found in a traditional DVD video that the users who intend to perform bilingual education through such a DVD video are greatly limited in operating it. A student who intends to learn a foreign language by such a limited DVD display system can only achieve limited results.

### SUMMARY OF THE INVENTION

Accordingly, an object of the present invention is to provide a DVD player which can display variable types of sentences on subtitles at the same time and a method for producing such subtitles. The system includes de-muxer unit, a subtitle generation unit, a video decoding unit, a video subtitle composing unit, video output apparatus and a subtitle producing unit. The method for producing a subtitle showing variable sentences simultaneously includes a fist step of extracting subtitle: decoding at least one language of subtitle data in a DVD video into decoded data and storing the decoded data into a series of graphic files; a second step of compiling subtitle graphic files: compiling background color and frame color of the stored graphic files to promote the accuracy of character recognition; a third step of transforming subtitle graphic files: transforming the compiled subtitle graphic files into a compiling-able text file in favor of establishing a subtitle displaying table; and a fourth step of storing to be subtitle displaying table: combining the text file and a displaying time code into a subtitle displaying table and then outputting the subtitle displaying table into a video subtitle composing unit. Thus, the subtitles in more than one languages displayed in the DVD video are shown with variable types of sentences at the same time. The sentences in the displayed subtitle are marked with each of their corresponding displaying time to benefit the users in browsing both the displayed and the un-displayed sentences. The users also can choose a sentence to serve as a starting location to start displaying the video. Thus, both video watching and language learning effects can be achieved by the users.

The present invention can be more fully understood by reading the subsequent detailed description and examples with references made to the accompanying drawings.

### DESCRIPTION OF THE DRAWINGS

FIG. 1 is a schematic view of a prior art DVD player;

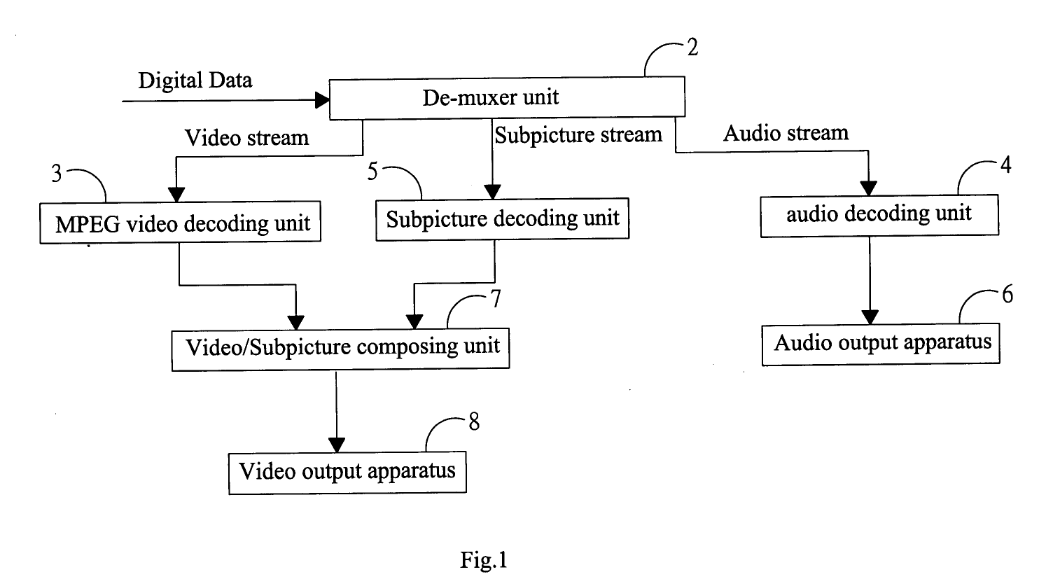

FIG. 2 is a schematic view of another prior art DVD player;

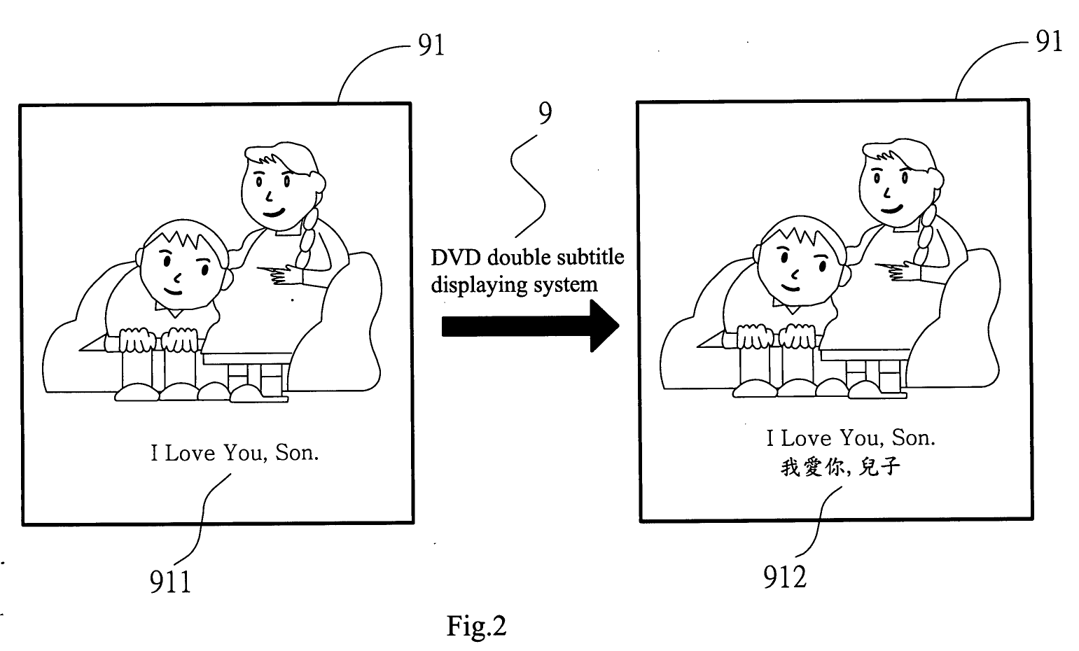

FIG. 3 is a schematic view of the DVD player according to the invention;

FIG. 4 is a schematic view showing steps of producing subtitles according to the invention; and

FIG. 5i is schematic view showing one embodiment according to the invention.

### DETAILED DESCRIPTION OF THE PREFERRED EMBODIMENT

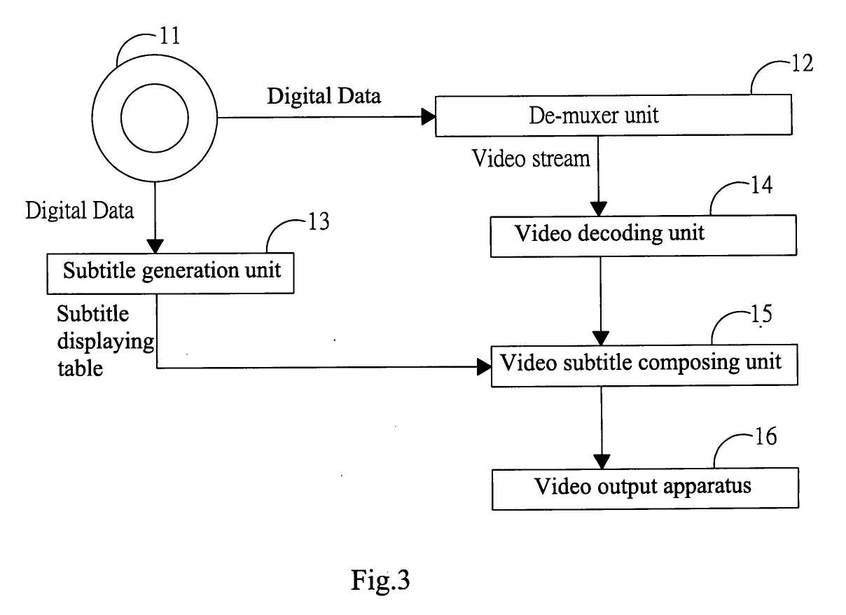

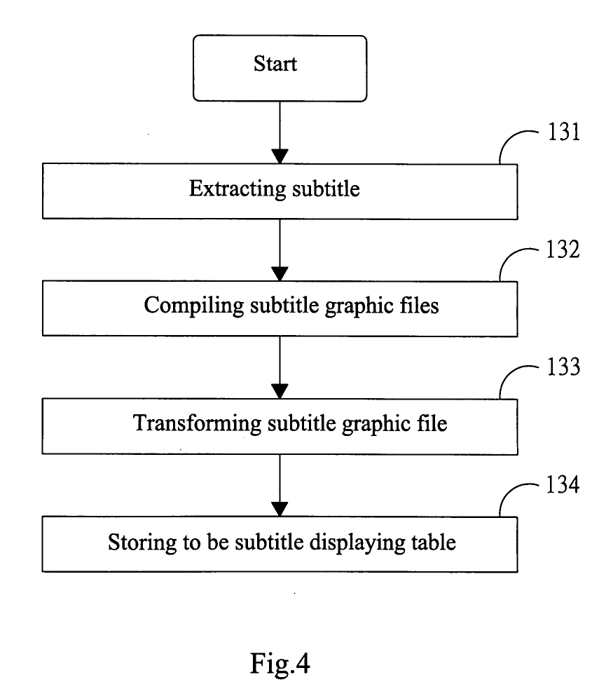

Referring to FIG. 3 and FIG. 4, a DVD player with function of displaying variable sentences simultaneously and method for producing subtitles thereof according to the invention are provided. The DVD player also refers to a system capable of serving as a bilingual learning system by using a DVD video containing multiple types of subtitles. The DVD player includes de-muxer unit 12 which transforms digital video data in a DVD disc 11 into video data stream and then outputs the video data stream to a video decoding unit 14. A subtitle generation unit 13 is provided to produce a subtitle reproduction file composed of more than one types of sentences in different languages. The method for producing the subtitles includes the following steps:
the first step of extracting subtitle 131: one type or more than one types of subtitle datum built in a DVD video, “*.VOB” files, are decoded into subtitle data at one time and then the decoded data are stored into a series of graphic files such as *.BMP, *.JPG and *.GIF.
the second step of compiling subtitle graphic files 132: the background color and the frame color of the stored graphic files are compiled to promote the accuracy of character recognition;
the third step of transforming subtitle graphic file 133: the compiled subtitle graphic files are transformed through character recognition into a compiling-able text file in favor of establishing a subtitle displaying table in following; wherein the character recognition is the well-known technology of optical character recognition (OCR); and
a fourth step of storing to be subtitle displaying table 134: the character file and the displaying time code are combined and stored into a subtitle displaying table and then the subtitle displaying table is transmitted to a video subtitle composing unit.

During the *.VOB file is read in the first step of extracting subtitle 131, all time codes of the subtitles (the time at which each sentence shows and the period each sentence lasting, both serving as information informing DVD player when and which sentence has to be displayed and how long the displayed sentence will sustain.) are achievable. A video decoding unit 14 is used to decode the video data stream to achieve decoded video data and then transmits the decoded video data to a video subtitle composing unit 15.

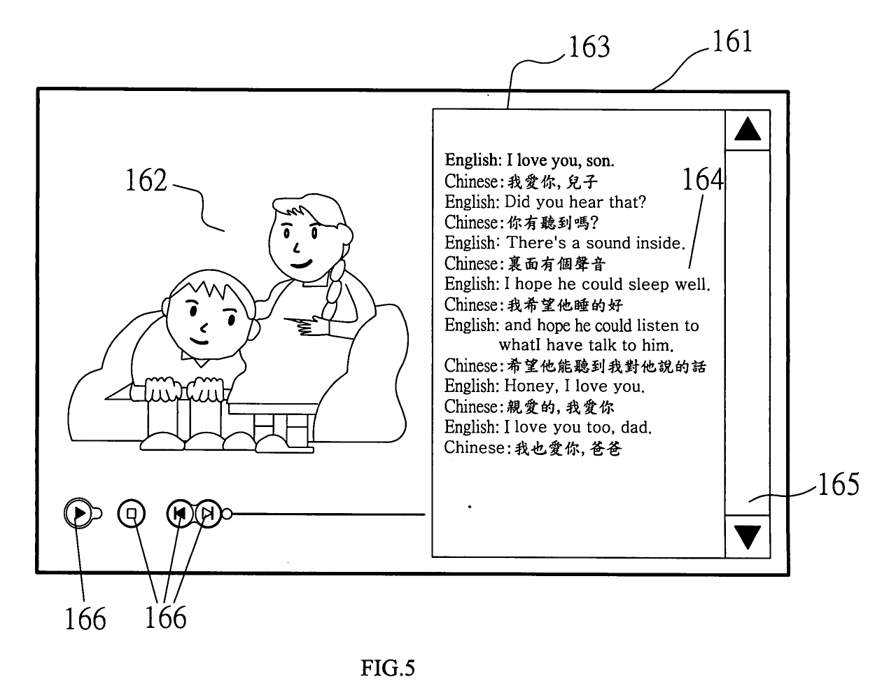

Referring to FIG. 5, the video subtitle composing unit 15 is used to link and then transmit the video data from the video decoding unit 14 and the subtitle displaying table from the subtitle generation unit 13 to a video output apparatus 16 so as to form a video subtitle 163 containing variable types of sentences in different languages. During the video data stream and the subtitle display file are combined and linked by the video subtitle composing unit 15, a browsing area 165 in which the users can browse both the displayed and the un-displayed sentences, and player function keys, such as a play key, a pause key, a stop key, a forward key and a backward key, are added in the video. At the same time, the sentences in the subtitle can be marked to show each of their corresponding displaying time and can be served as a starting location to start displaying the video. A video output device 22 is provided to display the video containing variable types of subtitles in different languages delivered from the video subtitle composing unit 21. In this case, the video output device 22 is screen 221. Through the video subtitle composing unit 21, the video and the subtitle containing variable types of sentences in more than one different languages are combined and linked, and then are transmitted to the video output device 16 so as to show off a subtitle containing variable languages in a multiple-sentences type at one time on the DVD video . The displayed sentences are marked with each of their corresponding displaying time, respectively, so that the users are benefited to browse both the displayed and the un-displayed sentences. The users further can choose a subtitle sentence to serve as a start location in order to start displaying the video. Thus, objects both of video watching and language learning are provided to the users.

Referring to FIG. 5, an embodiment according to the invention is shown. Through the DVD player with function of displaying several types of sentences according to the invention, the video 162 and the subtitle 163 are simultaneously displayed on the screen 161. The displayed sentence 164 will be marked through combining and linking the video data and the subtitle displaying table by the video subtitle composing unit 15. The displayed and the un-displayed sentences can be searched in the browsing area 165. Displaying functions such as play, pause, forward, backward and so on in video 162 can be controlled by displaying function keys 166 so as to benefit the users in learning the conversations in the DVD video, and thus a bilingual learning is promoted. The users will feel more interested with respect to the bilingual learning and drawbacks found in prior art bilingual learning are resolved by using the system according to the invention.

The system according to the invention is suitable for a next-generation DVD player such as a BD-DVD (blue-ray DVD) and a HD-DVD (high-definition DVD) player. However, a next-generation DVD player will not only provide the picture format existed in the original DVD but also the text format. With respect to a subtitle of the text format type, a fifth picture function can be achieved by the system according to the invention through executing the first step of extracting subtitle 131 and the fourth step of storing to be subtitle displaying table 134. Thus, the second step 132 and the third step 133 can be omitted. Additionally, when the first step of extracting subtitle 134 is performed, the subtitle of text type can be read out directly without storing into graphic files in advance. Subsequently, the fourth step of storing to be subtitle displaying table 134 is performed to complete the system of the invention.

Comparison between the system according to the invention and the prior art system is made to distinguish the progress and utility of the invention in following.

Drawbacks in the Prior Art System
1. only displaying subtitles with one or two language by a single sentence;
2. unable to browse both the displayed and un-displayed sentences on time; and
3. unable to provide perfect multi-lingual learning.

Advantages in the System According to the Invention
1. capable of showing more than one types of subtitles in a multiple-sentences type;
2. capable of browsing both the displayed and the un-displayed sentences on the video on time; and
3. capable of providing a better multi-lingual education environment.

Although the present invention has been particularly shown and described above with reference to the preferred embodiment, it is anticipated that alterations and modifications thereof will no doubt become apparent to those skilled in the art. It is therefore intended that the following claims be interpreted as covering all such alteration and modifications as fall within the true spirit and scope of the present invention.

What is claimed is:

1. A DVD player with function of displaying variable types of sentences simultaneously, comprising:
system resolution apparatus transforming digital video data in a DVD disc into video data stream and then transmitting the video data stream to a video decoding unit;
a subtitle generation unit producing a subtitle reproduction file composed of more than one types of sentences in different languages;
a video decoding unit decoding the video data stream to achieve decoded video data and then transmitting the decoded video data to a video subtitle composing unit; and
a video subtitle composing unit linking and then transmitting the video data from the video decoding unit and the subtitle displaying table from the subtitle generation unit to video output apparatus so as to form a video subtitle containing variable types of sentences in different languages.

2. A method for producing a subtitle showing variable types of sentences simultaneously, comprising:
a first step of interception subtitle: decoding at least one of subtitle data in a DVD video into decoded data and storing the decoded data into a graphic file;
a second step of compiling subtitle graphic file: compiling background color and frame color of the stored graphic file to promote accuracy of character recognition;
a third step of transforming subtitle graphic file: transforming the compiled subtitle graphic file into a compiling-able character file in favor of establishing a subtitle displaying table; and
a fourth step of storing to be subtitle displaying table: combining the character file and a displaying time code into a subtitle displaying table and then transmitting the subtitle displaying table into a video subtitle composing unit.
